(19) United States
(12) Patent Application Publication
(10) Pub. No.: US 2020/0203960 A1
(43) Pub. Date: Jun. 25, 2020

(54) Charging Technique for Series Cells

(71) Applicant: Apple Inc., Cupertino, CA (US)

(72) Inventors: Robert J. Hoyt, Sunnyvale, CA (US); Glenn D. Henshaw, Sunnyvale, CA (US); Narendra S. Mehta, Cupertino, CA (US); Shawn G. Fink, Cupertino, CA (US); Suchitra Pari, Cupertino, CA (US); Yasen I. Yasenov, Sunnyvale, CA (US)

(21) Appl. No.: 16/391,178

(22) Filed: Apr. 22, 2019

Related U.S. Application Data
(60) Provisional application No. 62/781,985, filed on Dec. 19, 2018.

(51) Int. Cl. H02J 7/00

(52) U.S. Cl. CPC H02J 7/0014; H02J 7/0021; H02J 7/007

(57) ABSTRACT

An electronic device has a battery system with control circuitry for use during charging and discharging. The battery pack has two battery cells coupled in series. The control circuitry includes battery charging circuitry that applies a charging current to the battery pack during charging. The control circuitry includes bleed resistors and switches that can be selectively activated to bleed charging current away from a selected cell during charging. This allows the control circuitry to balance charges stored on the cells and to balance associated cell voltages. The control circuitry is configured to maintain information on a difference between the charge stored on the first battery cell and the charge stored on the second battery cell. Information on this charge difference value is maintained during charging and discharging and is used in establishing a battery pack charging voltage target.

This application claims the benefit of provisional patent application No. 62/781,985, filed Dec. 19, 2018, which is hereby incorporated by reference herein in its entirety.

### FIELD

This relates generally to power systems, and, more particularly, to balancing battery cells in electronic devices.

### BACKGROUND

Electronic devices have battery packs. Some battery packs are composed of multiple cells. Battery cells may, for example, be coupled in series. Individual cell voltages in a series battery pack may become unbalanced due to differences in the amount of charge stored on the cells. This can pose challenges in ensuring that charge is spread appropriately across individual cells within the pack.

### SUMMARY

An electronic device has a battery system with control circuitry for use during charging and discharging. The battery system is used in a portable electronic item or other equipment. The battery pack has two or more battery cells coupled in series. The control circuitry includes battery charging circuitry that applies a charging current to the battery pack during charging.

The control circuitry includes bleed resistors and switches that can be selectively activated to bleed charging current away from a selected cell during charging. This allows the control circuitry to balance charge stored on the cells and to thereby balance the voltages of the cells.

The control circuitry is configured to maintain information a difference in discharge rates of the cells. During operation, the control circuitry can maintain information on a difference between the charge stored on the first battery cell and the charge stored on the second battery cell. Information on this charge difference value is maintained during charging and discharging and is used in conjunction with information on the open-circuit-voltage-versus-charge behavior of the cells in establishing a battery pack charging voltage target to use during charging.

The control circuitry halts charging operations when the battery pack charging voltage target is reached to avoid charging the cells to more than a desired maximum value (e.g., to avoid overcharging). A voltage sensor is used to measure the voltage of the battery pack across the terminals of the battery pack. Because the battery pack charging voltage target sets a satisfactory charging voltage level for the entire battery pack, the pack can be charged to the voltage target without measuring the voltages of the individual cells within the battery pack.

### BRIEF DESCRIPTION OF THE DRAWINGS

FIG. 1 is a schematic diagram of an illustrative electronic device in accordance with an embodiment.

FIG. 2 is a circuit diagram of illustrative battery circuitry in accordance with an embodiment.

FIG. 3 is a diagram containing graphs of cell voltage versus time in a battery pack in accordance with an embodiment.

FIG. 4 is a graph of an illustrative open-circuit-voltage-versus-charge characteristic for a battery cell in accordance with an embodiment.

FIG. 5 is a flow chart of illustrative operations involved in using an electronic device with cell balancing circuitry in accordance with an embodiment.

### DETAILED DESCRIPTION

Electronic devices contain battery packs (batteries) formed from multiple individual battery cells. Battery cells are connected in series and/or in parallel to form completed battery packs. A battery pack that has two battery cells connected in series may sometimes be referred to as a series-connected battery pack or a 2s battery pack. If desired, multi-cell battery packs can contain three or more cells connected in series.

It is desirable to balance the cell voltages on each of the individual cells in a multi-cell battery pack (e.g., each of the cells in a two-cell pack, a three-cell pack, or other types of multi-cell packs with cells electrically coupled in series). For example, in an electronic device with a 2s battery pack, it is desirable that the voltages on each of the two cells in the pack do not differ too much. This helps ensure that the cells maintain desired operating conditions, e.g., voltage levels.

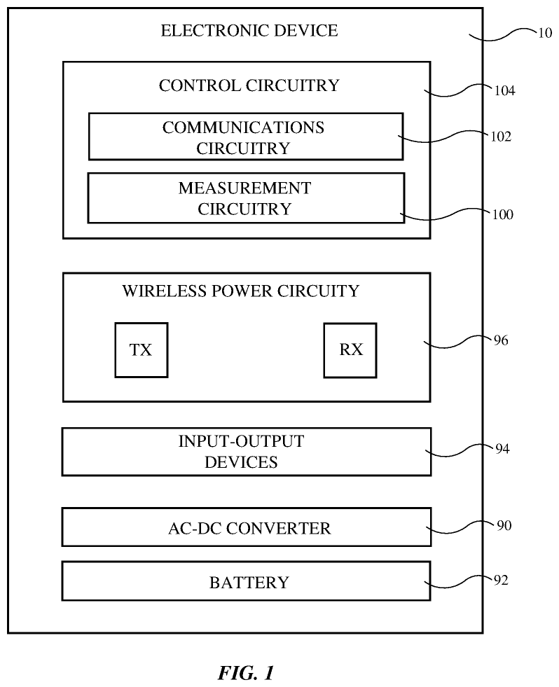

FIG. 1 is a schematic diagram of an illustrative electronic device that includes a battery pack with multiple cells coupled in series. Device 10 of FIG. 1 may be any suitable electronic device such as a power bank, wristwatch, cellular telephone or other handheld device, laptop computer, tablet computer, an accessory such as a pair of earbuds, a computer stylus (digital pencil), or a computer mouse or trackpad, and/or other battery-powered equipment (e.g., other portable electronic devices, etc.). In an illustrative configuration, electronic device 10 is a portable electronic device such as a battery case. The battery case may have a housing that is configured to receive another electronic device such as a cellular telephone. The battery case may have a battery pack (e.g., battery 92 of FIG. 1) that is used to provide supplemental power to the cellular telephone or other electronic device via a wired or wireless link. Battery packs with multiple cells connected in series may also be used in cellular telephones, accessories, and/or other electronic equipment. The use of a battery pack with two cells coupled in series in a battery case is sometimes described herein as an example.

The circuitry of FIG. 1 includes optional circuit components. One or more of these optional components may be omitted to reduce the cost and complexity of device 10. For example, components such as AC-DC converter 90 may be included to provide device 10 with the ability to receive alternating-current power or may be omitted to reduce cost and complexity.

As shown in FIG. 1, device 10 may include control circuitry 104. Control circuitry 104 may be used to control the operation of device 10. This control circuitry may include processing circuitry associated with microprocessors, power management units, baseband processors, digital signal processors, microcontrollers, and/or application-specific integrated circuits with processing circuits. The processing circuitry implements desired control and communications features in device 10. For example, the processing circuitry may be used in selecting coils (in scenarios in which device 10 includes multiple inductive charging coils), determining power transmission levels, processing sensor data and other data, processing user input, handling negotiations between devices (e.g., to establish power transfer settings), sending and receiving in-band and out-of-band data, making measurements, monitoring battery status, controlling battery charging, and otherwise controlling the operation of device 10.

Control circuitry in device 10 such as control circuitry 104 may be configured to perform operations in device 10 using hardware (e.g., dedicated hardware or circuitry), firmware and/or software. Software code for performing operations in system 8 is stored on non-transitory computer readable storage media (e.g., tangible computer readable storage media) in control circuitry 104. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 104. The processing circuitry may include application-specific integrated circuits with processing circuitry, one or more microprocessors, a central processing unit (CPU) or other processing circuitry.

Electronic device 10 may include input-output circuitry as shown by input-output devices 94 of FIG. 1. Input-output devices 94 may include light-based devices (e.g., displays, status indicator lights formed from light-emitting diodes or other light emitters, ambient light sensors, image sensors, optical proximity sensors, three-dimensional image sensors formed from light emitters that project beams of light and corresponding image sensors that detect dots where the projected light beams strike objects, camera flash components, and/or other circuits that emit and/or detect light), radio-frequency circuitry (e.g., radio-frequency circuitry such as radar circuitry and/or other radio-frequency circuitry for detecting the location and movement of objects), acoustic components (e.g., microphones for gathering sound and speakers for emitting sound), haptic output devices for providing vibrations and other haptic output, touch sensors, buttons, force sensors, joysticks, knobs, temperature sensors, gas sensors, and/or other circuitry for detecting user input and for measuring environmental data.

Device 10 may, if desired, include wireless power circuitry 96. Circuitry 96 may include wireless power transmitter TX for transmitting wireless power signals and wireless power receiver RX for receiving wireless power signals. If desired, transmitter TX and/or receiver RX may be omitted to reduce cost and complexity for device 10.

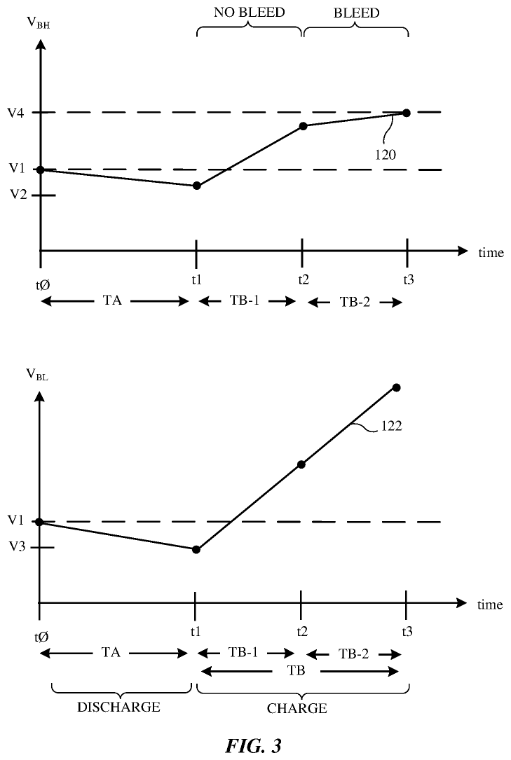

Device 10 may include wired or wireless communications circuitry such as communications circuitry 102 of FIG. 3. The communications circuitry may be used by device 10 to allow device 10 to communicate wirelessly with other electronic devices using in-band or out-of-band communications. Circuitry 102 may, for example, have wireless transceiver circuitry (e.g., a wireless transmitter) that wirelessly transmits out-of-band signals to an external device using an antenna. Circuitry 102 may also have wireless transceiver circuitry (e.g., a wireless receiver) that is used to wirelessly receive out-of-band signals from an external device using the antenna. Wired communications circuitry in circuitry 102 may be used to allow device 10 to communicate with other devices over wired paths. Wireless communications circuitry 102 can use one or more coils (e.g., coils in transmitter circuitry TX and/or receiver circuitry RX) to transmit and/or receive in-band signals (e.g., using frequency-shift keying, amplitude-shift keying, or other suitable modulation schemes). Measurement circuitry 100 (e.g., optional foreign object detection circuitry) may be used to detect when foreign objects are present on the charging coil(s) of device 10.

Alternating-current-to-direct-current power converter circuitry such as AC-DC converter 90 may be included in device 10 (e.g., to convert power from an alternating-current source into direct-current power for use in powering the circuitry of device 10).

Device 10 includes a battery such as battery pack 92. Battery pack 92 includes battery cells. In an embodiment, battery pack 92 includes two cells in a 2s (series) configuration. Battery pack 92 may be a lithium battery pack (e.g., a pack using lithium-based battery chemistry such as a lithium ion chemistry).

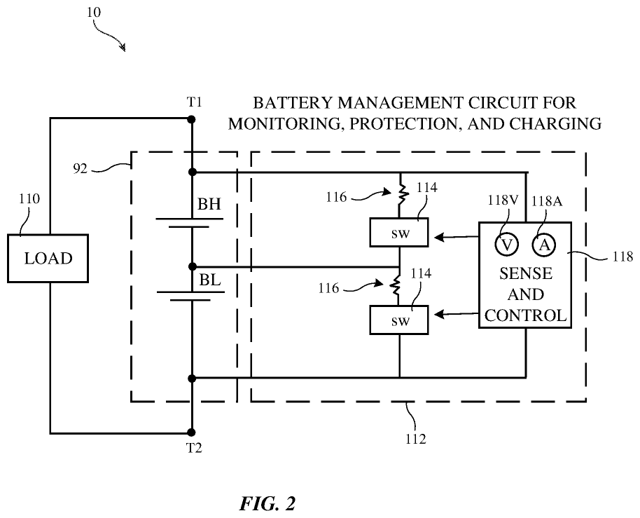

FIG. 2 is a circuit diagram showing circuitry associated with operating battery pack 92 in device 10. As shown in FIG. 2, battery pack 92 has first battery cell BH and second battery cell BL coupled in series between first battery pack terminal T1 and second battery pack terminal T2. During operation of device 10, load circuitry 110 (see, e.g., the components of electronic device 10 of FIG. 1 and/or the components of a cellular telephone or other external electronic device that is drawing power from device 10 through a wired or wireless power path between device 10 and the external electronic device) may be powered using power from battery pack 92. Batteries BH and BL may be asymmetric in that they may have different sizes and energy storage capacities.

Device 10 includes battery management circuitry such as control circuitry 112 (e.g., control circuitry forming part of control circuitry 104 of FIG. 1). Circuitry 112 may include sensor, charging, and control circuitry such as circuitry 118. Circuitry 118 has a voltage sensor 118V for sensing the voltage between terminals T1 and T2 and a current sensor 118A for sensing current flow through battery pack 92 (e.g., between terminals T1 and T2) and includes control circuitry for performing control operations. Circuitry 118 includes charging circuitry for applying current to battery pack 92 to charge battery pack 92 (e.g., current that flows through pack 92 from terminal T1 to terminal T2).

Bleed resistors 116 may be used to draw (bleed away) charging current from a selected cell during charging to help balance the cells. The control operations performed by circuitry 118 may include, for example, selectively opening and closing switches 114 when it is desired to bleed a given battery cell through an associated one of bleed resistors 116. For example, when the voltage on battery cell BH is higher than desired relative to battery cell BL, the switch 114 that is associated with battery cell BH may be closed by circuitry 118 during charging, thereby causing current that would otherwise flow through cell BH to charge cell BH to be bleed off through the resistor 116 that is associated with cell BH. In this way, difference in the charge stored on battery cell BH relative to the charge stored on battery cell BL may be reduced during charging, helping to balance the associated voltages on cells BH and BL. If desired, current can be bled in a non-charging state (e.g., an idle state). For example, current can be bled using electrical components in device 10 during an idle state.

The circuitry that is coupled to battery pack 92 (e.g., circuitry 112) creates uneven parasitic (quiescent) drain currents for cells BH and BL. These parasitic currents, which may be on the order of microamps in magnitude, may be measured during battery pack manufacturing. Information on the parasitic currents flowing from cells BH and BL when circuitry 112 is in a quiescent state can be stored in circuitry in device 10 (e.g., circuitry 118 and/or other storage in control circuitry 104 of device 10). This knowledge of the different parasitic drain currents between cells BH and BL may be used in helping to determine the amount of charge imbalance that develops between cells BH and BL. In turn, information on the amount of charge imbalance can be used (in conjunction with knowledge of the open-circuit-voltage-versus-charge characteristic of the cells) in determining when to halt charging to prevent excessive voltage on either of cells BH and BL, even in arrangements in which circuitry 112 (e.g., the voltage sensor in circuitry 118) is only capable of measuring pack voltage between terminals T1 and T2 and is incapable of individually measuring the voltages on cells BH and BL.

Cells BH and BL may be balanced by selectively bleeding current away from the cell that has more charge. Current may be bleed away from a selected cell by closing the switch 114 for that cell and thereby switching into use the bleed resistor 114 for that cell. By dissipating power through the bleed resistor instead of using the power to charge the higher-voltage cell during charging, the higher-voltage cell will charge at a slower rate relative to the lower-voltage cell during charging. This tends to balance the higher-voltage and lower-voltage cells. (Balancers may also be activated when device 10 is not charging.) Although not all charge balancing may be accomplished in a given charge cycle, the amount of balancing that is accomplished during each charging period tends to be much larger than the amount of unbalancing that is imposed on the cells during each discharge period due to the differences in parasitic currents between the cells. As a result, the voltages on cells BH and BL tend to converge over time (e.g., over a series of charge-discharge cycles). Non-intuitively, this balancing expends some energy into a bleed resistor (e.g., during charging), but allows the battery pack to provide an overall superior user experience (e.g., during discharging).

An illustrative discharge and charge cycle is shown in FIG. 3. As shown in FIG. 3, at time t0, battery pack 92 may initially have cells BH and BL that are balanced. For example, at time t0, cell voltage VBH of cell BH and cell voltage VBL of cell BL may both have a value of V1 at time t0 (e.g., cells BH and BL may be completely balanced). When discharging (not charging), cells BH and BL experience unequal parasitic current draw that causes cells BH and BL to become unbalanced. As shown in the example of FIG. 3, there is more parasitic current drain on battery BL than on battery BH during discharge period TA. This causes voltage VBH to drop to a voltage V2 and voltage VBL to drop to a lower voltage V3 (V3<V2) at time t1. As a result, cells BH and BL are unbalance (VBH is not equal to VBL) at time t1. There is no period of time during time period TA during which pack 92 is being used to power load 110, but, if desired, one or more such periods may occur during time period TA. During discharge of pack 92 through load 110, the cell voltages VBH and VBL tend to drop rapidly relative to the drop illustrated during time period TA of FIG. 3. These load driving periods (which may also interrupt a charging operation) are therefore omitted from the graph of FIG. 3 for clarity.

During charging time period TB between time t1 and time t3, cells BH and BL are charged by applying a charging current and charging voltage across terminals T1 and T2 (e.g., a charging voltage that exceeds the open circuit voltage of the pack) using circuitry 112. Initially, during period TB-1 between time t1 and t2, the bleed resistors in circuitry 112 may be switched out of use, so that both cells BH and BL are charged equally at a first (e.g., higher) rate. At time t2, when the voltage V3 on higher-voltage cell BH is close to the maximum desired cell voltage V4 (e.g., 4.35 volts or other desired maximum voltage), the bleed resistor for cell BH is switched into use using the switch 114 associated with that bleed resistor. This selectively bleeds power away from cell BH during charging, so that cell BH charges more slowly than cell BL (e.g., cells BH and BL are charged unequally during time period TB-2 between times t2 and t3). This is illustrated by VBH curve 120 and VBL curve 122 of FIG. 3, where curve 120 has a smaller slope (charge rate) than curve 122 between times t3 and t4 after the bleed resistor for BH has been switched into place at time t3. Because BH is charged less than BL during time period TB-2, the voltage VBL on cell BL tends to rise more than voltage VBH on cell BH. As a result, the operations of period TB-2 tend to balance the voltages on cells BL and BH.

During operation of device 10, the discharge and charge periods of FIG. 3 repeat. Over time, the amount of balancing that is performed during charging (periods TB) exceeds the amount of unbalancing that occurs during discharging (periods TA). As a result, the voltages on cells BH and BL tend to converge and pack 92 tends toward a balanced state.

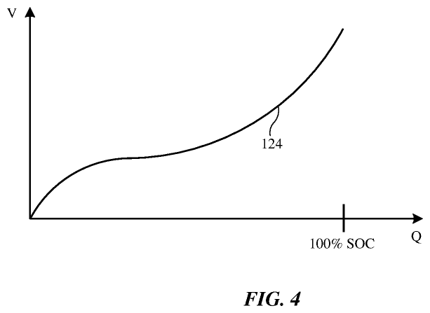

During charging operations, control circuitry 104 (see, e.g., circuitry 112 of FIG. 2) may use information on the characteristics of cells BH and BL to ensure that cells BH and BL are not overcharged. The parasitic current losses of cells BH and BL through circuitry such as circuitry 112 (e.g., parasitic currents Iph and Ipl, respectively) are characterized during testing (e.g., as part of a manufacturing process) and stored in circuitry 112 or other control circuitry 104. Cell voltage V versus cell charge Q characterization measurements are also made and corresponding open-circuit-voltage-versus-stored-charge is stored in control circuitry 112 or other control circuitry 104. As shown by open-circuit-voltage-versus-stored-charge curve 124 of FIG. 4, a battery cell exhibits an increase in voltage V for increasing amounts of stored charge Q. Stored charge Q may be represented in mA-hours or other units and varies from a small amount (when a cell is depleted) to a large amount (e.g., the full capacity of the cell in mA-hours in a situation in which the state-of-charge of the cell is at 100%). After measuring the V versus Q characteristic (curve 124 of FIG. 4) for each cell in pack 92 (or a representative cell from a batch of similar cells), this information (curve 124) can be retained for use by control circuitry 104 during charge management computations.

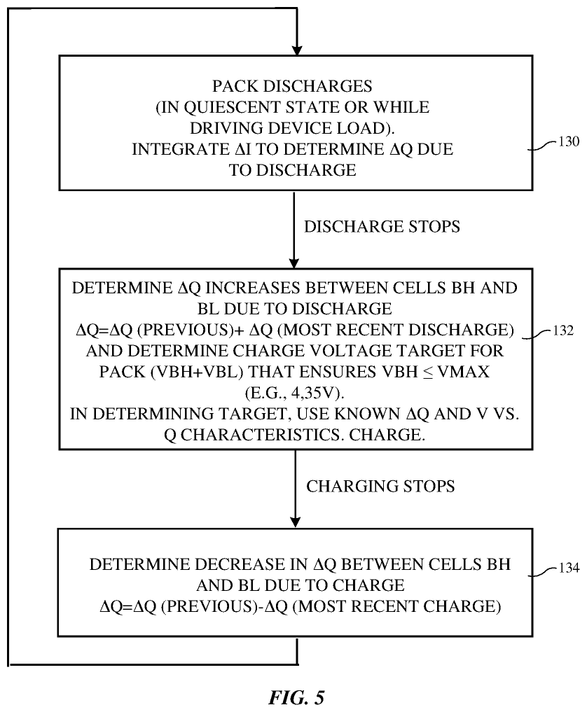

A flow chart of illustrative operations involved in balancing pack 92 during operation of device 10 is shown in FIG. 5.

During the operations of block 130, pack 92 discharges. Load 110 may be active and drawing relatively large amounts of current from pack 92 during discharging or load 110 may be electrically isolated from pack 92 so that the only current drawn from pack 92 is due to the presence of a quiescent load on pack 92. During discharging, the parasitic current drawn from cells BH and BL will differ, leading to charge unbalance between cells BH and BL. As described in connection with period TA of FIG. 3, for example, the parasitic current associated with cell BH (current Iph) may be smaller than the parasitic current associated with cell BL (current Ipl). As a result, a mismatch in parasitic discharge current ΔI=Iph−Ipl will be present. This leads to a corresponding difference ΔQ in the charge Q that is stored on cells BH and BL. In the example of FIG. 3, cell BH discharged slower than cell BL, so the charge QH on cell BH is larger than the charge QL on cell BL at time t1. The value of the mismatch ΔQ=QH−QL in stored charge on cells BH and BL can be determined by control circuitry 104 by integrating ΔI over time period TA.

When discharging stops at the end of time period TA, operations proceed to block 132. During the operations of block 132, control circuitry 104 (e.g., circuitry 112) determines the current (most up-to-date) value of ΔQ by adding the value of ΔQ produced during period TA to the value of ΔQ that was computed at the end of the last discharge period (e.g., control circuitry 104 maintains a running value for ΔQ and updates this information based on discharging activity). To prevent charging of cells in pack 92 more than desired, control circuitry 104 determines a battery pack charging voltage target Vtotal for pack 92 using ΔQ and the known open-circuit-voltage-versus-charge behavior of the cells. This target value represents the maximum desired voltage to be produced across terminals T1 and T2 (e.g., the maximum open circuit pack voltage to be obtained during charging). The value of Vtotal can be determined by predicting the voltages VBH and VBL for cells BH and BL, respectively and by setting Vtotal at a value that ensures that the higher of VBH and VBL (e.g., VBH in this example) does not exceed a desired maximum cell voltage Vcellmax (e.g., a desired maximum voltage such as 4.35 V or other suitable value).

In predicting the value of Vtotal that will cause voltage VBH to reach Vcellmax, control circuitry 104 uses the current value of ΔQ and the V versus Q characteristic of cells BH and BL. Control circuitry 104 takes into account the fact that cells BH and BL charge at the same rate during first charge period TB-1 and that cell BH charges at a slower rate than BL (due to the switched-in bleed resistor) during second charge period TB-2. The bleed resistor may be switched into use when a threshold in the state of charge of the higher-voltage cell is exceeded as determined by settings in control circuitry 112 (e.g., when the state of charge of battery BH exceeds an activation threshold of 98%). There is more charge current flowing into cell BL during period TB-2 than flowing into cell BH during period TB-2, so control circuitry 104 considers this disparity in charging current when computing the expected rise in BH over time. The value of QH (and therefore the resulting open circuit voltage VBH) can be computed by integrating the charging current into cell BH during both time periods TB-1 and TB-2. The expected rise in BL over time TB can also be computed by control circuitry 104 by integrating the charge current into cell BL during period TB. The bleed resistor for cell BL is not switched into use during period TB (in this example), so control circuitry 104 need not account for a reduction in charging current into cell BL during period TB-2.

During the operations of block 132, control circuitry 104 (e.g., circuitry 112) charges pack 94 until the value of Vtotal is reached. Circuitry 118 includes voltage sensor 188V, which measures the voltage across terminals T1 and T2. Circuitry 118 need not include (and, in an embodiment, does not include) any separate voltage sensors for independently measuring cell voltages VBH and VBL. Nevertheless, because control circuitry 104 determined an appropriate value of Vtotal taking into account the different charge states of BH and BL and taking into account the different charge rates of BH and BL during time period TB-2, the charging process of block 132 can be satisfactorily halted when the voltage of pack 92 reaches Vtotal (or, if desired, earlier due to an interruption of available charge power, commencement of a discharge cycle, etc.).

When charging stops, operations proceed to block 134. During the operations of block 134, control circuitry 104 determines the decrease in ΔQ that was achieved due to the balancing that has taken place during charging period TB. During one or more periods of time during charging period TB, the bleed resistors may be active and may help in balancing the cells. By accounting for these balancing operations, control circuitry 104 can determine the decrease in ΔQ that has been achieved.

If, for example, charging period TB was cut short by a need to begin discharging, not much balancing will have taken place (e.g., ΔQ at the end of the charging operations of block 132 will not differ significantly from ΔQ at the beginning of block 132). On the other hand, there will generally be periods in which significant charging takes place (e.g., sufficient charging to bring the pack voltage to Vtotal). In these longer charging scenarios, there is time for balancing to take place and control circuitry 104 can compute ΔQ from the integrated value of the difference in charge current supplied to BH and the charge current supplied to BL. During the operations of block 134, control circuitry 104 therefore measures the amount of time that charging took place during block 132 and accounts for any periods of time where the bleed resistor was switched into place (e.g., the period of charging after the activation threshold voltage was exceeded and the bleed resistor was switched into use to produce unequal charging rates and thereby balance cells BH and BL) and produces a corresponding updated value for AQ. Processing can then loop back to block 130.

The foregoing describes a technology that uses data communication in the context of power transfer operations. The present disclosure contemplates that it may be desirable for power transmitter and receiver circuitry to communicate information such as states of charge, charging speeds, so forth, to control power transfer. The above-described technology need not involve the use of personally identifiable information in order to function. To the extent that implementations of this charging technology involve the use of personally identifiable information, implementers should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. An electronic device, comprising:
a battery pack having first and second battery cells coupled electrically in series, wherein the first battery cell stores a first charge and the second battery cell stores a second charge and wherein, when the battery pack is in a quiescent state, the first battery cell is characterized by a first parasitic current and the second battery cell is characterized by a second parasitic current that is different than the first parasitic current; and
control circuitry configured to determine an increase in a difference between the first charge and the second charge due to discharging the battery pack for a discharge period by using information on the first and second parasitic currents.

2. The electronic device of claim 1 wherein the control circuitry is configured to:
determine a decrease in the difference between the first and second charge due to charging the battery pack for a charging period.

3. The electronic device of claim 2 wherein the control circuitry is configured to control charging of the battery pack using a battery pack charging voltage target.

4. The electronic device of claim 3 wherein the control circuitry comprises a first bleed resistor and first switch associated with the first battery cell and a second bleed resistor and second switch associated with the second battery cell.

5. The electronic device of claim 4 wherein the control circuitry is configured to close a selected one of the first and second switches to switch into use a selected one of the first and second bleed resistors during charging when a threshold state of charge on a selected one of the first and second battery cells is exceeded.

6. The electronic device of claim 5 wherein the control circuitry is configured to determine the battery pack charging voltage target to use based at least partly on information on when the threshold state of charge is exceeded.

7. Battery circuitry, comprising:
first and second battery cells coupled in series between a first terminal and a second terminal; and
control circuitry configured to measure a voltage across the first and second terminals and configured to track changes in a difference in charge between the first and second battery cells without measuring individual voltages on the first and second battery cells.

8. The battery circuitry of claim 7 wherein the first battery cell stores a first charge and the second battery cell stores a second charge, wherein when the battery pack is in a quiescent state the first battery cell is characterized by a first parasitic current and the second battery cell is characterized by a second parasitic current that is different than the first parasitic current, and wherein the control circuitry is configured to maintain information on a difference between the first and second charges during charging and discharging of the first and second battery cells.

9. The battery circuitry of claim 8 wherein the control circuitry is configured to determine an amount to increase the difference between the first and second charges during discharging of the first and second battery cells.

10. The battery circuitry of claim 9 wherein the control circuitry is configured to determine the amount to increase the difference between the first and second charges based on a duration associated with the discharging.

11. The battery circuitry of claim 10 wherein the control circuitry comprises switching circuitry and bleed resistors configured to balance the first and second battery cells during charging.

12. The battery circuitry of claim 11 wherein the control circuitry is configured to maintain the information on the difference between the first and second charges at least partly by determining when bleed resistors are switched into use during charging and at least partly by measuring charging duration.

13. The battery circuitry of claim 12 wherein the first and second battery cells form a battery pack and wherein the control circuitry is configured to use the information maintained on the difference between the first and second charges in determining a battery pack charging voltage target to use in charging the battery pack.

14. The battery circuitry of claim 12 wherein the control circuitry is configured to determine the battery pack charging voltage target using the information maintained on the difference between the first and second charges, charging duration information, and open-circuit-voltage-versus-charge information for the cells.

15. A battery system for an electronic device, comprising:
a battery pack formed from first and second battery cells coupled in series between first and second battery pack terminals;
a first bleed resistor and first switch coupled across the first battery cell;
a second bleed resistor and second switch coupled across the second battery cell;
a voltage sensor coupled between the first and second battery pack terminals;
control circuitry that includes charging circuitry configured to supply a charging current that flows through the battery pack between the first and second terminals to charge the battery pack, wherein the control circuitry is configured to:
control the first and second switches during charging of the battery pack to short a selected one of the first and second bleed resistors across a selected one of the first and second battery cells; and
control the charging circuitry to charge the battery pack to a target battery pack charging voltage target determined at least partly based on information on a difference between a first charge on the first battery cell and a second charge on the second battery cell.

16. The battery system of claim 15 wherein the control circuitry is configured to use open-circuit-voltage-versus-charge information for the first and second battery cells and the information on the difference between the first charge on the first battery cell and the second charge on the second battery cell in determining the battery pack charging voltage target.

17. The battery system of claim 15 wherein the control circuitry is configured to maintain the information on the difference between the first charge on the first battery cell and the second charge on the second battery cell during charging and discharging of the battery pack.

18. The battery system of claim 17 wherein the control circuitry is configured to compute an updated value of the difference between the first charge on the first battery cell and the second charge on the second battery cell following a discharge period using information on discharge period duration.

19. The battery system of claim 18 wherein the control circuitry is configured to compute the updated value of the difference between the first charge on the first battery cell and the second charge on the second battery cell following the discharge period using information on a first parasitic current drawn from the first battery cell through the control circuitry when the control circuitry is in a quiescent state and a second parasitic current drawn from the second battery cell through the control circuitry when the control circuitry is in the quiescent state.

20. The battery system of claim 17 wherein the control circuitry is configured to compute an updated value of the difference between the first charge on the first battery cell and the second charge on the second battery cell following a charge period using information on bleed resistor use during charging.
